(19) United States
(12) Patent Application Publication
(10) Pub. No.: US 2014/0342341 A1
(43) Pub. Date: Nov. 20, 2014

(54) Student assessment scoring

(71) Applicant: Willie Frank Rea, Pittsford, NY (US)

(72) Inventor: Willie Frank Rea, Pittsford, NY (US)

(21) Appl. No.: 13/999,234

(22) Filed: Jan. 31, 2014

Related U.S. Application Data
(60) Provisional application No. 61/849,795, filed on Feb. 4, 2013.

(51) Int. Cl. G09B 7/02

(52) U.S. Cl. CPC G09B 7/02
USPC 434/351

(57) ABSTRACT

Disclosed is a system comprised of several subsystems performing the functions associated with scoring and analyzing students' schoolwork, calculating and issuing grades, and storing students' achievements.

This application claims priority under 35 U.S.C. §119(e) from U.S. Provisional Patent Application No. 61/849,795, filed Feb. 4, 2013 by W. F. Rea.

This invention, Student Assessment Scoring, is a system comprised of several subsystems performing the functions associated with scoring and analyzing students' schoolwork, calculating and issuing grades, and storing students' achievements. The system's software provides real time assessment of students' mastery of study materials. It identifies areas of weaknesses for individual students and the student population using the application. It passively maintains students' daily and class attendance; and it creates and maintains students' short-term, intermediate, and long-term records. Lastly, it allows for human intervention as necessary.

Instructors will teach his/her class in their normal fashion and the application will score the students' schoolwork (warm-ups, practices, quizzes, tests, and exams) in real time with the push of a button—eliminating manually scoring students' work, calculating grades, entering grades into a database, communicating those grades, generating and printing report cards, and taking attendance. Specifically, the application will:
Passively take daily and class attendance
Score students' schoolwork
Send notification of absents, update attendance records, and apply attendance to students' grades according to the grading rubric
Create and maintain students' short-term, intermediate, and long-term records
Calculate grades and allow for manual intervention at the administration's discretion
Calculate a student's year-to-date grade on demand
Generate and print report cards
Compare students' achievements over time

The application addresses a need to readily identify weaknesses in students' understanding of lesson materials. It effectively scores wordy English compositions and mathematical expressions in answer to examination questions. It provides real time analyses, thereby permitting the instructor to alter lessons to address understanding deficiencies. It analyzes results and identifies group and individual weaknesses; it records group and individual results; and maintains short-term, intermediate, and long-term records.

With instructors having knowledge of students' level of understanding, lessons which students find most difficult, and the time to address individual student needs; real innovation may be brought to the classroom. Using this system, the purpose for scoring students' schoolwork shifts from “determining students' grades” to “helping students succeed”.

### DETAILED DESCRIPTION

The system consists of a central PC in each classroom running Linux operating system. This central PC is linked to students' (in the class) Android tablets, via wi-fi, for students' response to classwork queries—the central PC and tablets are linked into a working group and connected to a common LAN and servers. Software for the system resides on the PC while a virtual keyboard and student access screen resides on the tablets. An instructor, operating the central PC, grants and takeaway students' access to the systems' components and the tablets' environment.

Components of the software include:
Activity scoring and components software
Databases
   Staff—Instructors and schedules
   Students—Students and schedules
   Short term—Scored response sheets
   Intermediate—Scored assessment (response sheets) summaries
   Long Term—Grades and achievements earned over the students' academic life
   Lesson plans, questions, and answer databanks
   Controls: Calendars, grading rubric, schedules, and control variables
Activity answer keys
Students response (answer) sheets
Customer interfaces

The process begins by the instructor teaching lessons in his/her normal fashion. Upon assessing students understanding of the material (administering a practice, quiz, exam, or etc); students would enter their responses on system generated forms (response sheets) using tablets instead of writing on paper or marking an answer sheet.

Assessment Scoring

The premise of the scoring process is that instructors enter key terms of questions' answers into a key and write in the affirmative. Students must reflect these terms in his/her response (answer) to the question, may write in complete statements as prescribed by the instructor, and cannot negate the meaning expressed in the key. Processing confirms that these rules are followed. Negating the meaning expressed in the key results in zero credit for the question; although the student may have used all the terms of the key in his/her response.

Processing reads the key and responses, from all students, into a data structure. It then counts the number of students and the number of questions, and stores these counts for future use. Followed by searching for each element of the key in the response: looping through the key and responses with the key level, a constant, being the outer most loop; students being the second nested loop; key questions being the third nested loop; response to questions being the fourth nested loop; the key question elements being the fifth nested loop; and the response question elements being the inter most nested loop.

Scoring a question takes three forms: 1) an instructor supplied reduction factor in “available question credit” due to an infraction that applies to the response as a whole; 2) “calculated reduction” due to an infraction that applies to a term; and 3) the number of errors encountered in the response verses the number of terms in the key. Scoring a question may result in several reductions of a question's “available credit”. See adjusted formula—available credit.

If conditions are encountered requiring manual scoring of a student's whole response sheet (alteration of a response sheet's format, as an example), scoring of this student's responses is halted, processing generates a summary activity database entry (without the score), the instructor is informed of the infraction and that off-line scoring is required. Each time the system is turned on, processing will scan the off-line and manual scoring databases for off-line and manual scoring requests and give notice to the instructor.

As scoring proceeds, responses are checked to determine if they include terms that express the opposite meaning conveyed in the key. Then the key is checked to see if it contains such negating terms. If the key and response include such terms or they both exclude such terms, the ideals expressed are not contradictory—Prefixes are addressed when key and response elements are assessed.

The key is searched for terms that must be included in the response, terms that must not be included in the response, and if certain terms in the response must be capitalized. These scoring requirements are conveyed by the instructor in the form of special characters prefixed to key terms, and control variables in files and databases.

After an activity has been proctored; the instructor selects an activity from the dropdown window on the central PC's desktop and initiates the scoring process. Processing begins by printing the current date and time of this process run. Processing then brings the key and individual student responses into focus. The key and student's responses are parsed, into elements, based on a delimiter. A response statement such as: x=3 is interpreted as a response consisting of one alpha term, “x”; one invalid entry, “=” (equal symbol standing alone); and one numerical term, “3”—a valid math statement does not include spaces between terms.

Starting with the first student, the first question, for the first key term; processing loops through the terms of the response for each term in the key. It notes the terms in the key as correct if the key and response terms match or gets the next response term (for that question) if they do not. The key term is noted as incorrect if the key term is not found in the response. After the correct notation for the last key term for the current question has been posted; processing loops to the next question, and repeats this same routine. After the last correct notation for the last question of a student response has been posted, processing loops through to the next student. After posting the last correct notation for the last student; processing calculates the score for each question, scores the activity, performs its analysis, prints the results, and stores the results in appropriate databases.

As the application accesses terms of the response, processing determines if the student's response file format has been altered. If so, scoring the activity for this student is suspended and the instructor is notified to score the activity off-line. Further, processing detects skipped questions in the response and scores the activity accordingly. Upon finding a response; processing confirms that the key and response question numbers match and counts the number of terms in the key and response.

From a listing of threatening terms, processing determines if the student is threatening individuals or property. If such threats are found, the key is considered to determine if such terms are used there. Such terms are not considered a threat if they are found in the key and response. The instructor is alerted to review the student's response if a threat is determined to exist.

As processing proceeds, the key and response are put back together (excluding any extra spaces that may exist between terms) for processing where complete statements may be considered. The scoring criteria, control variables, and available credit points, for the question, are read from files and databases. These variables are read into a companion data structure (of the key and response data structure) where intermediate scoring results are stored, scores are calculated, and analyses are made.

Based on the question's scoring criteria (exact, true or false/multiple choice, manual, compositional, or open-ended) processing then scores the question based on that criteria.

Exact Scoring

Exact scoring of a question is prompted when processing encounters a question and exact scoring is specified. If the key has less than or equal a specified number of terms, the key and response must match exactly (including capitalization, punctuation, and sequence of terms). Where the key is longer than the specified number of terms: all key terms must be in the response, in the same sequence; spelling, capitalization, and punctuation matters; and the response cannot include any negating terms.

Should the key and/or response include mathematical expressions or functions, mathematical processing (described under default processing) will determine if the terms match.

The question is scored as specified by the instructor relative to:
Not capitalizing required terms result in a calculated reduction of available credit*
Response terms out of sequence result in a reduction of available credit
Including negating terms in the response will result in 100% reduction of available credit
The number of key terms found in the response verses the number of key terms: ((count of key terms found)/(count of key terms))×(adjusted question available credit)

* Reduction in available credit may be an instructor specified percent to reduce the available credit by for infractions that relates to more than one term (such as: the sentence is not capitalized); or it may be a calculated reduction due to in infraction that relates to one term (such as: the term not being spelled correctly when it was required to be)

Manual Scoring

When processing encounters a question requiring manual scoring, the process outlined below is performed—but no scoring is done:
The key for the question is copied to the manual scoring database, including all identification and scoring variables for that question. See manual scoring process.
The students' response to the question and its identifying variables are also copied to the manual scoring database.
Scoring of the activity continues except for the manually score questions.
The overall student scores for the activity, excluding the manually scored question values, are posted to the intermediate database.
The instructor is given notice that there are pending requests for manual scoring. Posting of this notice will continue as long as there are records in the manual scoring database.

True or False and Multiple Choice Scoring

If the scoring criteria is “true or false” or “multiple choice”; the student's response is restricted to a single term for “true or false” questions; or no more than the number of terms in the key for multiple choice questions. The idea is to prevent guessing or listing all possible answers. For “true or false” questions the instructor will enter a single letter (“t” or “F”, capitalization is not a concern) and the student may enter the word or letter: True (or t); or false (or F). If the key has the letter “T” or “f” (notation that the question is of type “true or false”) processing will capitalize the key and response terms. The key term is then compared to the first response term, or to the first character of the response term (if the word is used instead of the character); and the question is scored accordingly—100% of available question credit or 0% if there is no match.

If the scoring criteria is “true or false” or “multiple choice”, and the key does not have the “true or false” notation, it is considered to be a multiple choice question. Processing then considers the number of terms in the key and response as the number of response terms cannot exceed the number of key terms—where the response has more terms then the key, the question is scored as incorrect, none of the available question credit is assigned. The application then capitalizes the key and response and compares the key and response terms. It is not necessary that response terms be in the sequence of key terms but the response may not include negating terms. The score for the question is based on the number of key terms found in the response—(“number of key terms found” divided by “number of key terms”) multiplied by the available credit.

Scoring of multiple choice questions allows for misspelled words as defined under open-ended scoring.

Compositional Scoring

Activity scoring uses compositional scoring if it is specified in the scoring criteria. This methodology scores a question based on:
The minimum and maximum number of words (terms) used in the response, specified be the instructor. The number of terms that can be used in this criteria is not limited.
Sentence subject and verb agreement
Spelling
Capitalization
Punctuation
The absence of run-on sentences

The instructor will specify the number of terms to use in the composition; a percentage by which students may over/under run this term count; the percentage to deduct for term count over/under runs; the weight of key terms in scoring; and the percentage to deduct for infractions of the rules for: sentence capitalization and end punctuation, subject and verb agreement, spelling errors, punctuation errors, capitalization errors, and run-on sentences. Note that the instructor may specify certain terms be included in the composition to ensure that students address the requested subject.

Process begins by counting the number of terms in the response and determining if any deductions are required for infraction of the count rule (See the infraction deduction rule below). It then considers the key terms (if there are any) and fixes any penalties for omissions by searching for each key term in the response. This is followed by identifying the first sentence and determining if it begins with a capital letter and ends with end-of-sentence punctuation. A high word count (compared to historical word counts per sentence); repeated use of a word in a sentence; limited usage of the parts of speech; excessive use of nouns, pronouns, and verbs (not in a series); and no end of sentence punctuation determines if the sentence is a run-on sentence. Processing then assesses penalties for sentence capitalization, end-of-sentence punctuation, and run-on sentence.

Processing now turns to spelling within the sentence. The application accesses the system dictionary (this dictionary is a database with fields dedicated to root words, parts of speech, tense, form, and alternative spelling (especially if the word can be a proper or common noun); and appropriate vocabulary may be added) and determine if words in the sentence are spelled correctly, including capitalization. While the word is in focus, its parts-of-speech is noted and the occurrence of nouns, pronouns, and verbs is noted and whether they are singular or plural. Each word not found in the dictionary is considered an infraction.

During spelling check, the application noted the occurrence and sequence of nouns, pronouns, and verbs and here it checks if the noun's/pronoun's form (singular or plural) is the opposite of the verb's form. If the noun/pronoun and verb have the same form then an infraction is generated. Although processing considers the form of nouns and pronouns as they occur compared to verb forms as they occur in sentences; consideration is also give to finding nouns/pronouns and verbs in phrases and if their forms differ.

The application then repeats this operation on each sentence in the composition. It counts the infractions and calculates the score as described under “formula: composition scoring”. It accepts one word exclamation sentences, looks for a subject and verb in phrases (and accepts implied nouns, pronouns, and verbs), along with other parts of speech in sentences. It rejects continuous repetition of a term, or use of a word more than an instructor specified percentage of sentence terms. Multiple use of run-on sentences, excessively long run-on sentence, or continuous repetition of a word will result in a critical reduction in available credit (instructor control variable).

To aid the instructor in assigning over-under and occurrence rates; processing will display the number of infractions that will drive the composition score to a failing grade upon the instructor entering these rates into the control variables.

$$occurrence rate = \frac{\begin{matrix}( available credit ) - \\ ( \begin{matrix}( available credit ) \times \\ ( over \text{-} under deduction percent )\end{matrix} )\end{matrix}}{( number of key terms )}$$

Knowing the occurrence rate that will drive the available credit to zero; the number of infractions required to drive the composition score to a failing is:

((available credit)−(available credit×((failing grade)÷100)))÷(occurrence rate)

### Infraction Deduction Rule:

The penalty for infractions include an allowable rate (percentage for infractions above which penalties are assessed) and an occurrence rate (the percentage to deduct from the available credit for each infraction above the allowable rate. For example, if a composition has 300 terms and it is to be assessed using a 10% allowable rate and a 0.05% occurrence rate; after 30 infractions the application will begin deducting 0.0005 from the available credit for each occurrence after 30.

### Sentence Length Standard

There are two options for determining if a sentence is a run-on sentence. The first option is a fixed quantity, appropriate for the grade level, which the instructor would determine and enter into the system. The application will determine the standard for the second option by tracking the length of sentences for the class and begin to apply the standard after the length of 500 sentences have been posted.

This second option consists of taking the Nth percentile of the recorded sentence lengths, and applying the run-on sentence definition stated earlier, to determine if the sentence is a run-on sentence. All sentences longer than this value and not conforming to the definition of a sentence is deemed an infraction. The instructor will have the ability to adjust this Nth percentile value based on his/her experience with the class.

### Open-Ended Scoring

Default scoring is the scoring methodology that is applied if exact, multiple choice or true or false, compositional, nor manual scoring is specified. The process considers each word (term or element) in the key and attempts to find it or its root word in the response. It isolates the root word by stripping away any prefixes and or suffixes, and makes allowance for misspelled root words according to dictates of the instructor. Each attempt and failure to find a key root word in the response returns “match not found” and prompts consideration of the next response term as long as there is an additional response element to consider. After the last response term has been considered and the key term was not found, processing scores the term as an error. Scoring is based on the number of key terms found in the response verses the total number of key terms.

It then considers the key, and control variables, and if the response statement(s) must be capitalized and ends with end-of-sentence punctuation—notation is made of the outcome of these findings. Processing then considers the first key term and determine if it is a series or an “or” function. A series is specified as: “ser(element1,element2,element3, . . . ))” in the key and as “element1 element2 element3 . . . ” in the response. The key term elements are preceded by “ser(”, has a comma delimiter, and end with a right parenthesis. The elements of the student's response are listed in his/her desired order and uses a space delimiter—the possibility of there being extra spaces in the response is taken into account.

Processing (the series) capitalizes the key and response and compares each key element with its corresponding response element—numerical terms may be sent to the expression analyzer for valuation and alpha terms may be sent to the word analyzer for word determination. The failure of any response element to match its corresponding key element will result in the question being noted as incorrect. Any formatting errors in the key will result in processing issuing a request for manual processing as described under manual scoring.

The “or” function takes the form “or(element1 element2 element3 . . . : elementA1 elementA2 elementA3 . . . : elementB1 elementB2 elementB3 . . . )”. When “or(” is encountered, processing notes the key as an “or function” and scores the response using alternative 1 (“element1 element2 element3 . . . ”); alternative 2 (“elementA1 elementA2 elementA3 . . . ”); and alternative 3 (“elementB1 elementB2 elementB3 . . . ”) using open-ended scoring functionality; and assign a score for the question based on the alternative with the highest score. This function addresses the need in situation where students are asked to answer any one of three (or two) questions.

Running through the key and response data structure and getting a key term, initially from the first question; processing determines if the response satisfies the overall requirements specified by the key and reduces the available credit if it does not. At this point, any unusual character (including punctuation marks) found at the end of the key and/or response term is removed. Focusing on the first response term, processing determines if the key and response match without modifications and score the response accordingly if there is a match. A manual score request is generated for the question if processing encounters a situation that it cannot resolve.

Processing then considers any special requirements of the key term (one at a time) that must be reflected in the response:
If the key term must be capitalized in the response
If the key term must be in the response
If the key term must not be used in the response
If the key has a prefix
If the key is mathematical
   Notation of all the above that apply are logged and processing initiates searching the response for the key term.

Continuing; processing searches for each key term in the response, starting with the first key term. Searching the response for a new key term always start with the first response term for that question; however, a response term can be used only one time in answer to a question. The response term is noted as correct if a match is found or the next response term is considered until the last response term has been considered; then the key term is noted as match not found.

Upon having a key and response term in focus; processing determines if the key and response terms are numerical and selects another response term if both terms are not numerical or alphabetical—a term is alphabetical if it is not numerical.

A term is numerical based on inclusion of numbers; mathematical operations, functions, and/or symbols—a mixed term such as “five×2” is considered to be an alpha term. If the term is numerical, processing determines if it includes a unit-of-measure. A unit-of-measure is indicated by an underscore immediately following the last character in the string, followed by characters representing the unit-of-measure. For example: 5_f/s or Y_sftpmls. If a unit-of-measure must be included in the response and it is not or if the unit-of-measures do not match, a calculated reduction is applied to the available credit for that question.

Continuing processing of numerical terms, processing strips away any unit-of-measures and compares the key and response for a match without manipulation. If a match is found, the score for the response term is noted, else the expression evaluator is called.

Mathematical Scoring

Processing determines if the key and response are valid, that is:
The statement includes only variables, constants, functions, operations and parenthetical symbols—and does not include any undefined strings
That all variables have a value
That all constant, variables, symbols, and functions are separated by an operation
That all functions are valid
That paired symbols are paired
That statements do not end abnormally, such as with some symbol: =, (, + . . .

Processing then determines if the key and response match without manipulation and returns “match found” if there is a match or else it continues processing. First, it determines if the key and response terms represent coordinates in a plane—coordinates have the form (X,Y) or (X,Y,Z)—a left parenthesis, an x-coordinate, a comma, a y-coordinate; and possibly another comma and a z-coordinate followed by a right parenthesis; i.e.: (x-coordinate”,“y-coordinate”,“z-coordinate”) with no spaces between elements.

Coordinate processing continues if the key and response represent coordinates—else, it returns “match not found”. Coordinate processing then determines if a coordinate is represented by an expression or decimal; in which case, the expression is quantified as noted for expression and the decimal is rounded to the place value of the shortest mantissa. Corresponding elements are compared and “match found” is returned if the elements match and “match not found” is returned if they do not.

(Decimal rounding) Based on the number of decimal places in the coordinate with the smallest decimal count (for the key and response x-coordinates, and the key and response y-coordinate); 0.X5 is added to each opposing coordinate with the largest decimal count (the X is replaced by a “0” for each decimal place of the coordinate with the smallest decimal count—for a three place decimal, three “0”s would replace the X). The opposing x and y-coordinates are then truncated to the decimal count of the coordinate with the smallest decimal count—three places in this case. This is the rounding process applied in all cases where rounding is used—add a “.” followed by a 0 for each decimal place of the truncation point followed by a 5 to the number to be rounded; then truncate the number at the truncation point.

The key and response x-coordinates are compared; and the key and response y-coordinates are compared. If the x-coordinates and y-coordinates are equal, processing returns “match found” or else “match not found” is returned.

Turning to non-coordinate valuations; processing determines if the key and/or response statements represent an equation or inequality; if so, it parses the string into a left and right string. It then compares elements of the key statement to elements of the response statement and returns “match found” if there is a match. Else it returns “match not found” unless either the key or response includes a decimal, expression, or function; in which case further processing is required.

The key and response strings are converted into mathematical statements. That is to say; the strings are parsed into mathematical expressions: variables are assigned values, and functions are casted and quantified using Java functions (as necessary). The application returns “invalid math expression” (its equivalent) if the key or response does not qualify as valid mathematical expressions and manual scoring is requested.

Functions and expressions are quantified, as explained below, and all decimals are rounded to the decimal count of the key. Although the key may represent an equation or inequality; the instructor is encouraged to use only expressions and students are free to enter expressions or equations in their response. Thereby, comparisons of X and Y (where a key of: X=5×Z and a response of: Z×5=Y) is avoided in situations where the student's response qualifies for full credit. See virtual keyboard functions for a representative list of math functions.

Expressions/Functions Valuation

Functions takes the form function(expression, left element, right element, etc)—a function will have no elements if that is its normal form; such as, sine of 67 where it appears as sin(67). When functions are encountered; processing cast the key and response as Java functions for quantification, rounds the results, and return “match found” if there is a match and the function(s) are not terms of an expression. It returns “match not found” if the functions do not match and the functions are the sole terms of the expressions.

Expressions are parsed into variables, constants, operations, and functions. Values for unknown variables are assigned, constant variable values are confirmed, and values for functions are translated. Processing applies the principals of groupings, identity, associative, commutative, and distributive to derive a value for each expression.

Then values of the key are compared to relevant response values and “matched found” is returned if they match (if “exact scoring” called the process either “match found” or “match not found” is returned). The application will then determines if the key and response are reasonable representations of each other based on acceptable rounding differences entered by the instructor. Response values are rounded to the decimal places of the key before comparisons are made. “Match found” is returned if the differences are acceptable or else “match not found” is returned.

Upon receiving a reply of “match not found”, processing considers the next response term for the question. If this is the last response term for the question, the term is noted as incorrect. Processing then considers if the key should not have been in the response. It scores the term as correct if it is not found and it should not have been included. It assigns 0 available credit for the question if the term was categorized as “must be included”

Upon receiving a “match found” reply from math analyzer, processing considers if the term was categorized as “must not be included”. If so, it assigns 0 credit for the question. Processing then considers the UOMs and applies a calculated reduction in the available credit if the UOMs do not match. It then notes the term as correct and begin processing the next key term. If this is the last key term for the question, the next question is then opened. Processing assigns the question to manual scoring if “invalid math expression” or some other unresolved issue was returned from math analyzer (See manual scoring)

Alpha Scoring

Finding both terms alphabetical, processing strips away any prefixes, and selects another response term if only one term has a prefix or if the prefixes do not match. Processing then considers the terms: do initial characters of the terms match, are their lengths reasonably comparable, and do they include many of the same characters; and selects another term if these conditions are not loosely met.

Upon having alpha terms (terms that are not numeric) from the key and response that do not match but are close enough to warrant further inspection; the alpha analyzer is called. Here, the terms are stripped of any suffixes and the key and response are checked to see if they match without manipulations. “Match found” is returned is there is a match; else processing continues.

With all prefixes and suffixes removed, the residual is roughly the key and response root words. The root words match if the following conditions are met.
The initial characters of the terms match
An instructor proscribed acceptable percentage of key characters found in the response, based on the length
An instructor proscribed acceptable percentage of characters in the response that are in the same sequence as the key
The number of sequences found—indicative of misplaced characters. Example: a key of: there and a response of theer has two sequences: the and er.
The percentage deviations of terms length

Special consideration is given to spelling rules and words that change spelling when suffixes are added, such as wife to wives. Word analyzer returns “match found” if the criteria is sufficiently met as specified by the instructor or it returns “match not found”

Upon receiving a “match found” reply from word analyzer, processing considers the special requirements specified by the key term and notes the term as correct or incorrect accordingly. Some examples: if a key term must not be in the response and it is found, zero credit is earned for the question; if the terms match and the key term must be capitalized in the response and it is not, a “calculated credit reduction” is applied; and if the key term must be in the response and it is not, zero credit is noted for the question. The next response term is considered if the return is “match not found” or the term is marked incorrect if this is the last term in the response.

The application repeats this process for each key term, for each question, and for each student. After the correct/incorrect notation for the last term, for the last student has been made; processing scores the questions by applying the “earned credit” formula. It then sums the “earned credits” for all questions in each response sheet and prints the scored student responses, including: where infractions occurred; the available credit, the correct term count, and credit earned for each question—It also stores these results in short term storage for student/instructor review. It then ranks students' achievements and questions (questions students missed by less than 10% above passing, or instructor supplied value) and prints these results.

Assurances are made that “earned credit” does not exceed “available credit” nor fall below zero for a question; Bonus points are added (if this is the treatment selected) and assurances are made that the score, for the activity, does not exceed the available activity credit. Finally, processing stores students result summaries in the intermediate database where it is retrieved, and the grading rubric is applied to determine grades (including letter grades) for the course.

### Customer Interfaces

Students

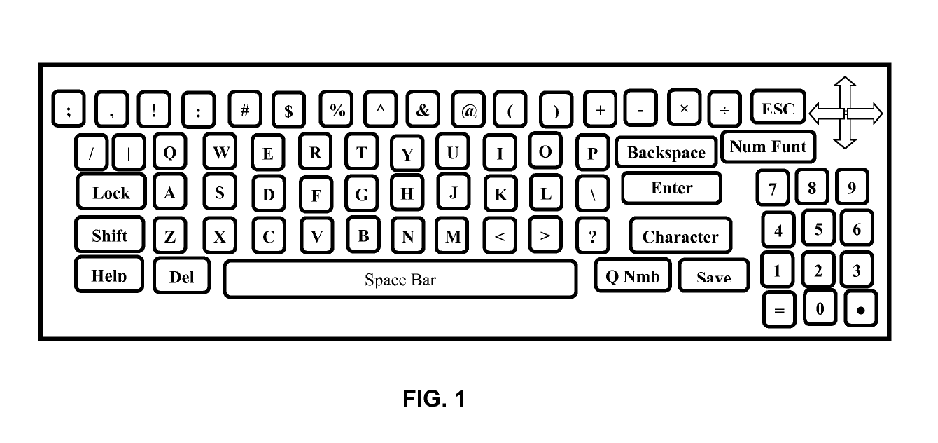

Students' first log-in (accessed from tablets) following the start of class generates class attendance as defined by school policy. The student's interface includes the virtual keyboard and buttons which provide access to the functions listed below. FIG. 1 is a representation of how the virtual keyboard appears.

### 1) Open/Edit Response Sheets

Pressing this button during the school day, students are presented the list of response sheets their instructors are allowing them to have access to at specific times during the day. Upon opening a response sheet, students may enter their response to questions in any order he/she chooses. Students would save their response sheets when they are finished, and the instructor controls the students' ability to reopen and edit saved responses during proctoring an activity.

### 2) Review Scored Response Sheets

Instructors activate this button (on the tablets) to allow students to open scored response sheets for review (these sheets cannot be edited). Scored response sheets available for review are specified by the instructor and have a shelf life based on district's policy—short-term database.

### 3) Review Year-To-Date Grade

Should the instructor enable this function; pressing the button, the system will generate the student's grade earned thus far this marking period. Processing will display the grade, the score by activity type, and the individual activity scores. These grades cannot be edited.

### 4) Save Response Sheets

After students complete responding to queries of an activity, they would save their work. With access granted by the instructor, students may select “save incomplete” which would save the file and students would be able to access it on another occasion for completion.

### 5) Review Seating Chart

The instructor will have created the seating chart and students may view it at the instructor's discretion.

During the school day, students will have access to scored and opened response sheets for only the instructor whose class they are in at the time—and only the response sheets which the classroom instructor grants access. During study hall and off-hours, students will have access to scored and opened response sheets of their respective instructors at the instructor's discretion.

Instructor

Instructors access functions of the application through the instructor's interface on the central PC. This interface list buttons which provide access to the functions listed below:

Response Sheets

### Create

Class—Create response sheet for all students in a class based on the answer key, the class, day, period, and students' schedule. A close date may be specified at this time—the number of days after the proctor date where students will no longer have access to the response sheet. Also, a closed date may be specified by activity type in control variables.
Individual Student—Useful should the instructor want a student to complete some missed or make-up schoolwork.
Review—Review response sheets before students completes them for an activity.
Find—The system will generate a list of completed response sheets for a specific student, class, day and period, or combination of these variables for the instructor to make a selection.
Delete—The instructor may specify the deletion date (days after proctor date) of unused and incomplete response sheets by activity type.
   This feature also allows an instructor to delete response sheets immediately where the activity has not been proctored in order to revise some instructor supplied information and regenerate the response sheets. Processing assures that duplicate response sheets are not created.
   The clean-up feature will erase all scored, incomplete, and unused student response sheets for a particular instructor.
   Routine processing will delete null and original response sheets that has been scored.
Save incomplete—Enable students to save incomplete work for later completion.
Note: An instructor may designate his/her class as a study hall, then students are able to access any opened homework or projects, or review any scored response sheets that their instructors have opened.

Answer Keys
Create—Creates a new answer key.
Edit—Information eligible for revision is limited for an answer key where the key has been used in the scoring process. Revision of the key's answers, number of questions, and control variables will result in creation of a new key.
Edit—Revision of a key that has not been used to score an activity is allowed as if a new key is being created and any existing data may be edited.
Review—Allows examination of the key's answers.
Find—The system will generate a list of answer keys based on the key ID, key name (key words), instructor's name, creators' name, class, activity type, creation date, or any combination of these variables.

Proctor Activity
Release—Releases an activity's response sheets for students' input.
Release Saved—Releases a(all) saved responses for a student(s) to edit or continue entering responses for an activity that is being proctored.
Close—Halts further student input to responses, saves students' responses, and returns tablets to the application's homepage.
   Processing give notice of the present of opened activities and displays a listing of which activities be may be selected and closed.
Timed: Should the instructor select the timed option; he/she would enter the duration of the assessment. The system will display the remaining time of the assessment for five seconds at the one-half and three-quarters marks, and continuously for the last five minutes on the tablets' display.

Score Activity
Opened Activities—All student completed response sheets will be scored for a particular teacher.
Selected activity—Only the selected activity, from a dropdown window, will be scored
Manual Score
   Off-Line—The activity is scored off-line and the score is entered here.
   Questions—System assisted manual scoring of questions categorized for manual scoring.
      In both cases, processing displays a listing of activities to select for scoring and provides a field for the instructor to enter a score.

Edit/Review Activity Scores
Review/Edit—Lists scores by activity type for a specific student, class, or period. If the edit function is selected an input field is provided for an addend to the activity type score
Delete—Deletes all student scores for a specific activity, class, or period.
   Note: Edits and deletions of student scores prompt administration notification according to administrative policy

Grades
Calculate Grades
   Student—For a specific student, displayed on screen
   Class—For a specific instructor—these may be saved to a file for review purposes. Sanctioned grades are initiated by an administrator or IT.
   All Classes—For an instructor—these may be saved to a file for review
Adjust Grade—Used to adjust grade due to some extenuating situation. An input field is provided.
   Activity Type—Adds an adjustment to the activity type grade for a student
   Student—Adds an adjustment to the final calculated student grade
Print Grades
   Class—For a specific instructor, to a file for the current year
   All Classes—For a specific instructor, to a file for the current year

Classroom
Class Roster
   Create—Per district's policy
   Edit—Per district's policy
   Review/Print
Seating Chart
   Create—Each student's name, in the class, will appear on a tile which may be moved to any opened position on the classroom grid.
   Edit—Permits moving student titles to a different opened position.
   Review/Print

Scoring Control Variables

Set instructor control scoring variables—for a specific class and/or subject. The application presents input fields and a brief description of each variable.

Grade Rubric

Enter/Edit—grading rubric for a class or subject and level. A rubric specifies the proportion each school activity contributes to the grade for the class.

Class, Period, and Student Changes

Should there be an unplanned change in the day, class, period, or student(s) schedule; the instructor may specify the day, class, period and/or student(s) for the current time—These changes will exist for the life of the class period. Pressing the button below and selecting or typing and entry converts the running schedule to the schedule selected/entered.
Day—Pressing this button, an entry field is displayed where the day may be revised.
Class—Pressing this button, a listing of classes is displayed and the instructor may select a class by clicking on it.
Period—Pressing this button, a listing of class periods is displayed and the instructor may select a class period by clicking on it.
Student—Pressing this button, the instructor is presented the option of entering a name or student ID; and an entry field is displayed for that purpose along with an add/remove button. The add/remove button will display remove if the student is currently assigned to the class or it will display add if the student is not assigned to the class..

### IT/Admin

School Calendar

Create

Edit

Review/Print

Day

The day (A B C . . . ) and period schedule for a specific day are edited on the log-in screen. The first day follows the last day in the sequence. Here day schedules are:

Create

Edit

Review/Print

Schedule: Listing of the periods in the day along with each period's start time and duration, and class change duration.

Create

Edit

Review/Print

Edit Key/Response Location (where stored)

Key path
Instructor
Class
Day/Block

Response Path
Instructor
Class
Day/Block

Calculate Grades

Specified grade level

Specified class

All instructors

Generate report cards—for all instructors

Release Grades

Edit/review

Release (post or mail)—parents will have access

Analysis

Calculate cumulative GPA for students

Rank Students

Compare current class performance versus previous class(es)

Rank questions from archive based on frequency of incorrect answers

Rank classes over time based on class performance

Calculate attendance reports:
Students
Days Absents
Minutes Tardiness
Ranking of student attendance
Absent rate comparison verses previous years

Cumulative minutes absent current year and current year vs previous years.

Note: District's absent rate is defined as:

(equivalent days absent)÷(weighted student enrollment)
Clicking on a selection entails highlighting a selection using the arrows key and pressing the enter key

### Processes

Off-Line Scoring

Off-line scoring is a process whereby the instructor can enter the score for an activity, for a student, that he/she has score off-line. This process is activated on the central PC instructor's screen; and it is used in situations where processing abandons scoring of a student's activity due to some technical infraction. When an instructor initiates the process; a drop-down window is displayed where he/she may select the class, student, and activity for which he/she would like to enter a score. The summary entry for the activity, except for the score, would have been created when the infraction was encountered. The instructor would enter a score from 0 to 100 and the system would convert the integer to a decimal and apply it to the activity's earned credit.

Manual Scoring

When manually scoring single questions, weather instructor or system generated, this process is followed. When activated, the system will display the key for the first question and the first student's response for that question. The instructor will score that question and enter the score as an integer from 0 to 100. The score for the question is determined by: ((integer entered)/100)×(the question's available credit). Processing would add the resulting question score to the score earned earlier and advance the display to the same question for the next student. After processing the last student's response for the question, processing advances to the next question and repeat this process.

Class Participation

With students signed onto the system, the application polls processing by students. The application tracks the duration of certain processes for each student while an activity is being proctored—from the time the first student opens the activity until the instructor closes (or student saves and exits) the activity. During scoring, processing will record and track: the number of questions in the activity, the number of questions students provided a response, the number of questions students scored less than 10% above failing (referenced going forward as LT10AF), and the number of responses that students received some credit. These three elements along with the proctoring duration will comprise the elements of the participation score. The weight each element brings to the formula will depend on the district's policy. But clearly, a student participating in all assessments, providing a response to most questions and performing (scoring on the activity) near or above historical levels will receive the highest class participation score. While a student not providing a response for all classroom assessments, having a high question skip rate, and/or achieving assessment scores short of historical performance levels would receive a lower class participation score.

Processing will access the participation tracking database and consider all class assessments and calculate the percentage of assessments each student took—that is: (number of assessments a student took)÷(total number of assessments proctored). For assessment percentages (each student took) less than 90% (an instructor control variable), the application will consider the class absents record and remove assessments where the student was legally absent from the “total number of assessments proctored” from the calculation.

Next, the skip rate is considered—the number of questions a student did not provide a response. For each student, processing will subtract the (number of responses a student provided) from the (total number of questions in the assessment), yielding the questions a student did not provide a response. Where LT10AF is above a prescribed percent of the total questions, processing considers the amount of time students spent taking the assessment. For processing duration less than 15% of the median duration time (the time a student spent entering responses) the application assigns a value of zero to LT10AF.

Duration rate=(student duration time)÷(total duration time)

Class participation rate for an activity is defined as: 100
Where the student scored greater than 80% and the duration rate is greater than a prescribed value

### Else

LT10AF is defined as:

LT10AF=LT10AF×(duration rate)
rounded to an integer
   The activity's question skip rate is then determined by the formula:

(number of question not having a response)+LT10AF)+(the total number of questions)

Class participation=(activity score)×(score weight)+(1−skip rate)×(skip weight)+((number of assessments taken)÷(number of assessments proctored))×(assessment weight)

The cumulative class participation rate for the marking period is then determined by the formula:

cumulative participation rate=(“previously accumulated” activity participation rate)×((number of questions in the “previously accumulated” activity participation rate)÷((number of questions in the “previously accumulated” activity participation rate)+(the number of questions in the activity rate being added))+(“activity participation rate” the activity rate being added)×((the number of questions in the activity rate being added)÷((number of questions in the “previously accumulated” activity participation rate)+(the number of questions in the activity rate being added)).

Attendance

Attendance is captured each block/period students log on to the system. After some time specified by policy, the application captures the name of each student that is not logged-on and send notices of absence as specified. Attendance of students absent the current class period is shown for assigned classes earlier in the day. With a policy of students logging onto the system up to five minutes before class and being on the system at attendance time, the application tracks cumulative tardiness duration along with frequencies across all classes for each student. Coupled with full day absents and frequencies, the application can reflect attendance on students' grade if that is the school's grading policy.

An absence for a school day is defined as not being present for any block/period in the school day. Tardiness is applied to the attendance rate by accumulating the minutes missed from all classes (for a student) and each summation equivalent to a school day is assigned one day's absence. Plus the frequency of being tardy above a prescribe rate equates to an absent for grading purposes. The instructor has the ability to edit these absences from class and note them as legal.

Should a student be excused during class, he/she should be instructed to logoff the system as class participation rate will be impacted as long as an activity is being proctored, the student is logged on, and no responses are being entered. After the start of class and the first log-on, and there is a subsequent log-on, the instructor is alerted anytime a student who logged-on initially does not log-on after this initial log-on. The instructor can intervene with the student or mark the absence as legal; this policy is implemented via control variable.

Answer Key

Creation of an answer key is prompted by the instructor on the instructor's screen of the central PC. The instructor is prompted to enter an activity name and total activity points; select an activity type, course level, and number of questions. The application will generate a unique key ID, and control fields; supply the creator's first and last name; and the creation date. A record of these fields is assigned to the first row of the key.

Based on the number of questions and the total possible score for the activity; processing assigns the question's available credit and question number for each record—these may be edited. When the available question credits are entered or edited, the system will display the sum of the questions' available credits; and will not allow the key to be saved if the sum of the available question credits exceed the available points stated for the activity.

Bonus question(s), may be included in the activity and control variables will specify how the bonus points are handled: credits may be added to the earned score for the activity (which cannot exceed the given points for the activity) or the credits may be accumulated, over the grade marking period, and achieving specified bonus levels qualifies for graduated credits being added to the earned grade for the marking period—which cannot exceed 100.

Available credit for questions are derived:

Questions 1 through (N−1):

available credit=(activity total possible points,C)÷(the number of questions,N)

### Question (N)

available credit=C−((C÷N)×(N−1))

The instructor then adds elements (terms or words) to each record, constituting the answer key for the question.

Master keys can be created by an instructor(s) and shared with associates within a school, a district, or state(s). Editing a key created by someone else or a key which has been used in the scoring process will result in a new key being created—the key's question elements are retained. Questions for activities may also be entered into a database along with the answer key; thereby, instructors may track students' success for specific questions over time; assign questions for specific subjects and difficulty level or enable self-study.

Instructors may:
Edit a null key (the key is absent of any key terms): processing will open the key and display all its fields and records. The instructor may edit any of the instructor supplied fields, except the number of questions—fields that cannot be edited are highlighted. The primary purpose of this edit is to enter answers for an activity for scoring.
Edit a key that has been used to score an activity: The key cannot be edited. Processing will allow use of the key's fields and records in creating a new master key as described below.
Create a new key: processing will create a master key as described under “master key creation”. And it will
   Display headings and generate all system controlled fields and IDs numbers
   Display fields for the instructor to make an entry or select a:
      Activity Name
      Subject
      Grade level
      Available points for the activity
      Number of questions (this number excludes bonus questions)

Keys are kept indefinitely, are stored on the LAN and require manual deletion, except where the life of the key has been prescribed. By identifying the key to colleagues, instructors may share keys. Keys are creator specific and response sheets are class and instructor specific.
Note: Master keys are not used; and therefore, it is not required that they be fully established at the time an activity is proctored. Completed master keys are required to score an activity.

A general list of activity types for which keys may be created include:

Warm-ups

Homework

Classwork

Weekly quizzes

Chapter tests

Unit tests

Quarterly exams

Mid-term exams

Final exams

State Exams (may or may not contributed to overall grade)

Independent work and research

labs

Generally, a copy of answer keys and opened response sheets associated with classroom related work are stored on the classroom PC, while response sheets used outside of class are stored on the LAN—homework and projects are good candidates for LAN storage.

Student Response Sheet

The application creates student response sheets when the instructor presses the create response sheet button on the instructors' central computer display screen. Processing provides the option to create response sheets from an existing answer key or create response sheets for a new activity. If “existing answer key” is chosen; processing supplies the instructors' name and the activity's identity fields, and allows the instructor to select the class, date, and period for the class; and edit the activity's name (day/block is supplied when proctored). Processing then creates a response sheet for each student assigned to the class based on students' schedules and the activity's identification information from the key. The instructor then releases these response sheets to students at will.

In cases where the instructor selects “create response sheets for a new activity”; the instructor would select a class, day, and block/period. He/she would be prompted for information as described for “create master key” and all instructor supplied fields may be ignored (for now and edited later) except for the number of question and activity's name. Processing would generate the response's ID, creation date, a response sheet for each student in the class, and the initial null answer key (the answer key would be completed by the instructor prior to scoring the activity). During the scoring process, processing would supply the identity data from the key and responses to the activity summaries.

Response sheets include the key's ID information (including the key ID code), the response ID code, control variables, and the student's and instructor's names in the first row. The question number is assigned as the first element of each record. From the key file information and response sheet input, response sheets are generated for specific classes or individuals when needed or stored in folders prior to proctoring an activity.

Parents may have access to certain types of response sheets (instructor or district's prerogative) and they may receive notice of their existence; and students may have access to certain response sheets while away from school. Scored response sheets are kept for a specified number of weeks (or several months), district's policy; are backed-up daily; and students and parents may have access to these results during the lifetime of the file. The life cycle of response sheets include:
New, awaiting usage
Incomplete, the response sheet was save before completion with the intentions of later completion.
Completed, student has finished his/her input and the file is awaiting scoring.
Scored, the completed response sheet has been scored and the results may be reviewed. Completed original response sheets are deleted from the system after scoring and the scored response sheet, which retains the original input, replaces it. By use of a control variable, completed response sheets may not be deleted immediately after scoring; in cases where the instructor wishes to edit the key answers and have the opportunity to score the activity again.
Dead, the scored response sheet has been deleted from the system. A summary of the scored response sheet results have been saved to the intermediate database.

Regarding secured exams, response sheets are saved to a secured folder and students are given access to this folder just prior to instructing them to open their answer sheet file. Response sheets are generated for all students authorized to take the exam by the exam administrator selecting students by class and day/period, class, or level and range of names. As with all response sheets, individual students can access and open only the response sheets he/she is authorized to open.

Processing maintains a list of proctored activities that have not been scored and give notice of this fact. Instructors may select individual activities to score from this list or specify score all not scored activities.

Instructors cannot edit response sheets.

Grade Adjustment

When instigated on the central PC instructor's screen, processing presents a list of activity types for the instructor to select and enter a grade adjustment. Processing will display an entry field for the adjustment quantity and apply the quantity to the selected activity type adjustment record. Upon generating the score for the activity type, the adjustment record quantity is added to the score for the activity type—the adjustment quantity may be positive or negative.

Processing also allows adjustments to a student's overall grade via an adjustment quantity placed in an adjustment field. The overall score for the activity's grade will be determined by adding the earned score plus the adjustment quantity. Notice of grade adjustments are provided to administration; and grade adjustments can not be made after the grading period has been closed and postings make to the permanent database; in line with district's policy.

Codes
Day: A through Z, any sequence of letters that repeats
Block or Period: 01-10 (whatever is needed)
Day/Block: Day(s) code plus the block code such as AC05 (day code letter or combination of letters, followed by the two character period code)
Level: Refers to grade of the student or classification. Examples include grades 5 and college freshman

Security and Access:

Who can access and/or perform certain functions in the system is determined by the security database. Students, instructors, administrators, and technical support each will have a level of security allowing them to perform functions pertaining to their position. One designee (and a back-up) is the only person authorized and able to edit and update the security master.

Fields in this DB include:
Customers' First Name
Customers' Last Name
Customers' ID Number—the field used to identify individuals.
Level—The customer type (instructor, student, and etc). This field derives the access level
Access—A series of fields listing the files types and databases specific customer groups and individuals may access and specifies the kind of access these groups and individuals may have: read, write, edit or a combination of these features.

Day and Schedule

Today's date and day will be saved as YYYY-MM-DD and A, B, or C at the end of the current school day. When the system is turned on, the next day, the system will advance the day sequentially, based on the day of the last school day—day A follows the last day in the cycle of days. Processing will display the last school date and day, and the current date and day on IT/administration's screen; and give IT/administration an opportunity to change, select a different, day.

The schedule for the day (sequence of blocks) may be specified by IT/administration each day, with the regular schedule being the default—the default schedule is used if another schedule is not specified. These schedules are listed in a database as noted below.

Generating the day's schedule

The day's schedule is determined by the clock regarding where we are in the day.
1) Access the current time using the NOW( ) function formatted as 24 hour clock and displayed in hours and minutes
2) Access today's block schedule (regular, delayed, SOAR or others)
3) Convert the periods' start, duration, and class change times to 24 hour clock
4) Convert the 24 hour clock times determined in step 3 to minutes
5) Convert the current time to minutes
6) Based on the current time in the day, the day (A, B, C, . . . ), and the schedule; the application determines the block based on current time being equal or greater than the block start time and less than the block end time.

With the start time for the first class, the duration of the classes, and the duration allowed for changing class; the system generates the schedule for the day by.
1) Begin with the school start time in 24-hour clock converted to minutes
2) Add class duration (determines class end time and start of class change interval)
3) Add class change duration (determines the start of the next class)
4) Repeat steps 2 and 3 for each block in the period
5) The instructor's class schedule during the lunch break may include time for the class and lunch
   Should the lunch period duration equal the class duration, then the lunch period is treated as a class period.

Note: To covert from 12-hour clock to 24-hour clock: remove the A.M. or
P.M. designation and add 12 hours if the time was stated as P.M. and the hour was equal to or greater than 1. Assign zero to the hour element if the resulting hour, after adding 12 hours, is equal to 24.

To convert from 24-hour clock to 12-hour clock, append A.M. to the time if the hour is less than 12 or equals 24 (0 hours). Append P.M. if the hour is greater than 11 and less than 24; and subtract 12 hours if the hour element is greater than 13 and less than 24. Assign 12 to the hour element if the hour is greater than 23 or equals 0.
The conversion of hours and minutes time to minutes is: hours×60+the minutes.
The conversion of time from minutes to hours and minutes is: minutes÷60. Of the resulting decimal number, the characteristic is hours, and the minutes are determined by multiplying the mantissa by 60.
To add or subtract time convert the time to 24-hours minutes and do the mathematical operation.

Calendar

A list of calendar days with school days noted by their A, B, C, . . . day designation; and the start and end date of each marking period. These marking periods may have designations such as semester, quarter, summer or similar notations. Processing will access the NOW( ) function, and based on the date in the calendar determine the marking period. Closing the marking period (calculating grades and performing marking period close functions) will be instigated manually. Holidays are not noted in the calendar as any day the system runs is considered a work day and a day and schedule may be specified. However, when the administrator or IT logs on he/she is presented the following message and asked to confirm.

| | |
|---|---|
| The last school date was | Friday Nov. 2, 2013 |
| The last school day was | C |
| Today is: | |
| Monday Nov. 5, 2013 | Source: NOW( ) |
| It is the First Semester | There is a dropdown window to allow |
| | selection of a period |
| Today is a D day | There is a dropdown window to allow |
| | selection of a day |
| Today's schedule is REGULAR | There is a dropdown window to allow |
| | selection of a schedule |

The default schedule will run unless an administrative or IT customer selects a day (A, B, C, . . . ) and/or period schedule to run. Period schedules may include: regular, 1-hour delay, 2-hour delay, SOAR, and/or other schedules. Based on the day and current time; processing will read the student, instructor, class, and period schedules and make the instructor's classwork assessable only to students assigned to him/her class during the period. Should there be a change in any schedule or student assignment, the instructor has the ability to specify the day, class, period, and students for the current period.

The application will also aid in development of instructors, students, and classroom schedules. Students are assigned to classes based on curriculum requirements, students/parents preferences, and class availability. Instructors are assigned to classrooms based on classroom functions, needs, and previous room assignments; and to classes based on instructor's certification area, needs, and previous class assignments.

Generating ID Numbers

Staff and student ID numbers will be six characters long and will include the numeric characters 0-9; and the capital letters A through Z except for the letters E, H, L, and X. These characters will be placed in a two dimensional array with row 0 occupied by the designated numeric and alphabetic characters starting in position (0,1). The second row, starting in (1,1), will contain the randomly generated sequence of the indexes for the first row. And the third row, starting in (2,1), will list the six randomly generated indexes of the characters' indexes which comprise the ID Code.

Key and response ID number generation will follow the process for students and staff ID number generation but will consist of five characters

Processing will then confirm that an ID code is unique.

Databases

Student Responses

Response sheets are computer generated files created for students to enter replies to queries concerning their schoolwork. They are generally stored on the LAN and have a short life span—Student completed originals are deleted two days after successful scoring; and scored responses are deleted at a time designated by school policy. Should some general error occur during the initial scoring, the originals may be rescored any number of times; and the new results would over write the existing results—new summaries are not created.

Scored response sheets constitute the short-term database.

Answer Keys

Answer keys contain the answers to queries posed to students and constitute the standard for scoring students' work. Aside from the answers, it contains control variables that pertain to specific questions. Keys have an infinite lifespan and may be shared with other instructors who use the system. Keys are generally stored on the LAN, but a copy of active keys may be stored on the central PC, keys waiting to be used in the scoring process. Processing will erase keys from the central PC in conjunction with deletion of completed response sheets.

Activity Summary—Intermediate Database

Activity summary database records are summaries of the scored student responses. These records form the basis for students' grades, and have a life span which covers the current marking period. The numeric and letter grades (either the numeric or letter, or both) may be printed and used in any reporting document. Instructors and/or students may view the year-to-date grade for a student (an instructor can also view grades for his/her class(es)) at any time.

Processing displays/prints numeric and letter year-to-date grade, the supporting numerical grade by activity type, and (optionally) a listing of the activity summary scores.

Permanent Database

Permanent database records list grades earned by students over the course of the student's academic life. These records are used to generate report cards, transcripts, and long-term performance statistics; and they are retained for a period defined by district policy. These records are backed-up and may be viewed in-line with district's policies.

Calendar, Days and Schedule

The calendar is represented by a listing of dates and days of the school year. Although all days in the calendar year may be listed, school days are noted by an A, B, C, or similar designation, and the first day in the sequence is preceded the last day in the cycle.

The schedule database lists the time slotted for various school functions and activities, primarily classes, during the various school days.

The summer schedule will operate like a regular school year.

Participation Database

Cumulative records of students' participation statistics.

Databank

The system allows storage of lesson plans, lessons, and exercises. From this databank, instructors can identify lessons, questions, and practices which individual students may work on as part of a lesson or self-study. Also from this database, reports of students' successes regarding questions' difficulties and racking, and comparisons over time may be generated.

Students' entries, typing on the tablets, wraps around in the display area as the length of the entry exceeds the display length—only one question is displayed at a time. Pressing the enter key on the tablet does not insert a new line. The scoring process validates that a line has not been inserted because there may be instances where a PC or LapTop is used to complete a response sheet and a line may have been inserted using these devices.

Character Keys

Pressing a character key results in the character on the key being displayed/entered on the screen or in a file.

Special Keys
Backspace: Deletes the character to the left of the cursor.
Character: A call key to display special characters not shown on the keyboard.

Pressing this button results in a display of special characters which may be selected by clicking on a character. The display also gives a brief definition of the characters.
Crossed Arrows Acts as a mouse to display questions sequentially: [symbol] moves the cursor to the next or previous question, and [symbol] moves the cursor to the left or right through the question currently displayed, one character at a time. The shift and [symbol] keys moves the cursor to the first or last question; while the shift and [symbol] keys moves the cursor to the beginning or end of the displayed question
Del: Deletes the character to the right of the cursor
Enter: Selects the highlighted function. It does not insert a line
ESC: Escape key, exits the function or character operation currently in focus
Help: A call to the instructor for help—the student's name flashes on the instructor's or designated screen. The instructor or designated help may see the student's entry but can not make an entry for the student. The instructor or designate help may type a suggestion, and cause the suggestion to be displayed on the student's screen.
Lock: Pressing this key turns capitalization of letters on or off.
Num Funt: Displays math functions. Students would press the function key, scroll to the desired function on the dropdown window using the arrows keys, and press the enter key to select a function.
Q Nmb: A link to a specific question number. Press the “Q Nmb” key and enter the question number to displayed a specific question on the screen
Save: Saves the open response sheet to the appropriate directory and clears the display. The student is given the option to save as complete or incomplete.
Shift: When pressed simultaneously with an alphabetic key, the character displayed will be the opposite of that of the locked status; with lock off, alphabetic characters will be capitalized; and with lock on capitalized letters will be displayed as lower case letters.
Space: Enters a space

Representative lists of virtual keyboard functions and special characters include:

Functions:
logical “and”: symbolized by an “&” symbol
logical “or”: symbolized by a “I” symbol
log: symbolized by log(expression)
sine: symbolized by sin(expression)
cosine: symbolized by cos(expression)
tangent: symbolized by tan(expression)
arcsine: symbolized by a sin(expression)
arccosine: symbolized by a cos(expression)
arctangent: symbolized by a tan(expression)
limit: symbolized by lim(expression, variable, point, direction) direction is indicated by a positive or negative 1
Scientific notation: has format: number, decimal point, an integral relative to the desired precision, a capital e, and a number (positive or negative) indicating the position of the decimal point in standard form. Examples include: “3.7E8” or “3.7658E-3”
triangle*: symbolized by tri(A,B,C)
matrix*: mat(element_{—}1 element_{—}2 element_{—}3; element_{—}4 element_{—}5 element_{—}6; element_{—}7 element_{—}8 element_{—}9) defines a 3×3 matrix
matrix rank*: symbolized by rnk(matrix_name)
   * Specifies a shortcut for defining some mathematical terminology

Special Characters:

−—negative sign

√—radical

|(expression)|—absolute value

{ }—braces

[ ]—brackets

±—plus or minus

e—Euler's number

Π pi

°—degree

∞—infinity

!—factorial

C(n, k)—combination

P(n, k)—permutation

∩—intersection

∪—union

Ø—empty set

∈—an element of the set

∉—not an element of the set

≦—less than or equal

≧—greater than or equal

≠—not equal

\tilde{E}—means of x

Ì—means of y

τ—transpose

l—line

[symbol] —line

→—arrow

∥—parallel lines

≠—not parallel to

⊥—perpendicular lines

∠—angle

≅—congruent

~—similar

∴—therefore

ƒ—function

∂—partial derivative

Σ—summation

∫—integral

P(x)—probability

Δ—delta

θ—theta

∉—small epsilon

ψ—psi

ω—small omega

Ω—capitalized omega

μ—mu

σ—small sigma

Formulas

All scorers are stored in rounded format.

Question Credit:

Available Credit: questions 1 through N−1 (these may be edited)

(activity total possible score)/N
: question N:

(activity total possible score)−(accumulated available credits for questions 1 through (N−1)).
: Available question credit is rounded to 3 decimal places.

### Adjusted Available Credit:

available credit=(available credit)−((available credit)×((reduction integer)/100))
Note: reduction integer is a percentage entered as an integer by the instructor indicating the penalty to reduce the available credit for certain infractions
   Available credit will be reduced by each infraction requiring a reduction of available credit. Each subsequent reduction is based on the original available credit value.

Calculated Reduction

A reduction in question available credit due to a term infraction such as not being capitalized.

calculated deduction=(question available credit)×(1÷(sum of key terms+3))

Credit earned for a question is determined as:

earned credit=(“adjusted” available credit)×((question correct terms summation)÷(number of key terms summation)−(summation of calculated deductions)

Question earned credit rounding

Rounding is achieved by adding 0.05 to the question's interim earned score and truncating to one decimal place. The earned score is then restricted to the rounded adjusted available credit in cases where the calculate earned credit exceeds the available credit; or 0 in cases where the calculate earned credit is reduced below 0.

Compositional Scoring

composition score=available credit−((sum of infraction−(sum of terms×allowable rate)×occurrence rate)×(1−weight))−(weight×((number of key terms found)÷(number of key terms))−(summation of calculated reductions)

Note: weight is an instructor supplied control variable which specifies the impact of not including key terms in the composition.

Percentile Calculations:

Where the percentile “P” is defined as (0≦P<100)

N is number of ordered values

n is the rank

Pₙ=(100/N)×(n−½)

n=(P/100)×N+½

### Example

Given Events: 15 20 35 40 50

P₃=(100/5)×(3−½)=50 the 50th percentile

If you are 14th in a class of 200 your rank is 186.5 and your percentile is:

200−14+0.5=186.5/200=0.9325=93 percentile

Marking Period Grade—Calculation for a Subject

A student's grade (in a class) for a marking period is based on the weighted average grade earned in the various categories of his/her schoolwork for that class; which may includes: warm-ups, class participation, practices, homework, projects, quizzes, attendance, tests, and exams; as specified by the school district. When calculating grades, the number of activities proctored, along with the number of questions, in each category are counted The weight of each activity's score is dependant on the number of questions in the activity verses the number of questions in that category.

To determine the score for each activity type the number of questions in each activity category is summed (typqstsum). Then the score is determined by:

$$\begin{matrix}Activity type score = \\ activity\_ 1 score \times ( activity\_ 1 number of questions / typqstsum ) + \\ activity\_ 2 score \times ( activity\_ 2 number of questions / typqstsum ) + \\ activity\_ 3 score \times ( activity\_ 3 number of questions / typqstsum ) + \\ \begin{matrix} ⋮ & \times & ⋮ & / & ⋮ & +\end{matrix} \\ \begin{matrix} ⋮ & \times & ⋮ & / & ⋮ & +\end{matrix} \\ \begin{matrix} ⋮ & \times & ⋮ & / & ⋮ & +\end{matrix} \\ ( type score adjustment )\end{matrix}$$

The grade for the subject (for the marking period):

The grading rubric will provide the weight each component of the grade will contribute to the overall grade for the class; that is:
Class Grade is equal to the summation of grades earned for all grading components times their respective grade weight:

(warm-up weight)×(warm-up grade)+(class participation weight)×(class participation grade)+(practice weight)×(practice grade)+(homework weight)×(homework grade)+(project weight)×(project grade)+(quiz weight)×(quizzes grade)+(attendance weight)×(attendance grade)+(test weight)×(test grade)+(exam weight)×(exam grade) . . . +(bonus points*)+(adjustment to grade)

If adding bonus points to the grade was elected.

School Year Grade Calculation

The formula used to derive the grade for the year is: (period1 grade)×(period1 weight)+(period2 grade)×(period2 weight)+(period3 grade)×(period3 weight)+ . . . As in:

(first semester grade)×50%+(second semester grade)×50%

or

first quarter grade×25%+second quarter grade×25%+third quarter grade×25%+fourth quarter grade×25%

Grade Point Average

With credit hours assigned to letter grades according to the district/institution grading system, the GPA for a student is determined by:

Total credit hours=summation of the (credit hours) attempted*

Total grade points=summation of (credit hours×course credit)

GPA=(total credit hours)÷(total grade points) “rounded to one decimal place”
where:
Credit hours is the numeric values of letter grades appropriate for the grading system
Course credit is the credits hours attributed to specific courses/classes (eleventh grade physics may have 4 course credits, as an example)
* Attempted referrers to courses excluded from calculation. This exclusion may include withdrawals, incomplete earned grades, audited courses, and etc.

Variance Calculations

Variance calculations is defined as: ((current year results)−(previous year results))÷(previous year results)

Notes

A customer cannot be logged on to the system at multiple stations. The system will post the customer logged-on at a station on the screen.

What is claimed is:

1. (canceled)

2. A networked computer system for student assessment scoring, comprising:
a computer operating in response to software;
a plurality of student tablets, wirelessly connected to the computer, where each of said tablets is capable of displaying a virtual keyboard and student access screen thereon;
at least one database for storing test, student, scoring and grade data;
a subsystem, operating on said computer, said subsystem performing a scoring process for scoring students' schoolwork;
a subsystem, operating on said computer, for analyzing students' schoolwork;
a subsystem, operating on said computer, for calculating and issuing grades, and
a subsystem, operating on said computer, for storing students' achievements.

3. The system according to claim 2, wherein said subsystem, operating on said computer, for scoring students' schoolwork further includes:
automatic assessment scoring of a student submission using a looping process to detect the presence of stored key terms in a student response;
automatic exact scoring of a student submission by direct comparison of a stored scoring key to the student response; and
manual scoring, including an instructor display of pending responses awaiting manual scoring.

4. The system according to claim 3, wherein automatic assessment scoring of a student submission includes an adjustment selected from the group consisting of:
an instructor supplied reduction factor in “available question credit” due to an infraction that applies to the response as a whole;
a “calculated reduction” due to an infraction that applies to a term; and
a number of errors encountered in the response versus the number of terms in the key.

5. The system according to claim 4, wherein the computer includes a display and where a dropdown window is provided on the display for a teacher to initiate the scoring process after an activity has been proctored.

6. The system according to claim 3, wherein said subsystem, operating on said computer, for scoring students' schoolwork further includes a compositional scoring operation, said operation comprising:
a user specifying (i) a number of terms to use in a composition, (ii) a percentage by which students may over/under run this term count, (iii) a percentage to deduct for term count over/under runs, (iv) a weight of key terms in scoring, and (v) a percentage to deduct for infractions of the rules for sentence capitalization and end punctuation, subject and verb agreement, spelling errors, punctuation errors, capitalization errors, and run-on sentences;
counting a number of terms in the student response, comparing the number of terms to the specified number of terms and percentage of over/under run of term count to determine if any deductions are required in a student's score;
comparison of key terms to the student response and if any key terms are not found fixing penalties for such omissions;
analyzing the student response using rules for sentence capitalization and end punctuation, subject and verb agreement, spelling errors, punctuation errors, capitalization errors, and run-on sentences and assessing penalties for errors of sentence capitalization, end-of-sentence punctuation, and run-on sentences;
accessing a system dictionary and determining if words in a sentence of a student response are spelled and capitalized correctly, and repeating this operation on each sentence in the student response before calculating a score.

7. A method for student assessment scoring, comprising:
operating a computer in response to software;
wirelessly connecting a plurality of student tablets to the computer, where each of said tablets displays a virtual keyboard and a student access screen thereon;
storing, in at least one database, data for tests, students, scoring and grades;
performing a scoring process for scoring students' schoolwork;
analyzing students' schoolwork;
calculating and issuing grades, and
storing students' achievements.

8. The method according to claim 7, further including:
automatic assessment scoring of a student submission using a looping process to detect the presence of stored key terms in a student response; and
automatic exact scoring of a student submission by direct comparison of a stored scoring key to the student response.

9. The method according to claim 8, wherein automatic assessment scoring of a student submission includes making an adjustment where the adjustment is selected from the group consisting of:
an instructor supplied reduction factor in “available question credit” due to an infraction that applies to the response as a whole;
a “calculated reduction” due to an infraction that applies to a term; and
a number of errors encountered in the response versus the number of terms in the key.

10. The method according to claim 9, further including displaying a dropdown window for a teacher to initiate the scoring process after an activity has been proctored and student at least one student submission received.

11. The method according to claim 8, further including a compositional scoring operation, said operation comprising:
a user specifying (i) a number of terms to use in a composition, (ii) a percentage by which students may over/under run this term count, (iii) a percentage to deduct for term count over/under runs, (iv) a weight of key terms in scoring, and (v) a percentage to deduct for infractions of the rules for sentence capitalization and end punctuation, subject and verb agreement, spelling errors, punctuation errors, capitalization errors, and run-on sentences;
counting a number of terms in the student response, comparing the number of terms to the specified number of terms and percentage of over/under run of term count to determine if any deductions are required in a student's score;
comparison of key terms to the student response and if any key terms are not found fixing penalties for such omissions;
analyzing the student response using rules for sentence capitalization and end punctuation, subject and verb agreement, spelling errors, punctuation errors, capitalization errors, and run-on sentences and assessing penalties for errors of sentence capitalization, end-of-sentence punctuation, and run-on sentences;
accessing a system dictionary and determining if words in a sentence of a student response are spelled and capitalized correctly, and repeating this operation on each sentence in the student response before calculating a score.

12. The method according to claim 8, further including a class participation assessment, said assessment comprising:
for students signed in, polling of processing by students tracks the duration of certain processes for each student while an activity is being proctored, measuring from a time a first student opens the activity until an instructor or student closes the activity;
record and tracking (i) a number of questions in an activity, (ii) a number of questions a student provided a response to, (iii) a number of questions students scored less than 10% above failing, and (iv) a number of responses that students received some credit on; and
calculating a participation score based upon the at least one of the group consisting of: the number of questions in an activity, (ii) the number of questions a student provided a response to, (iii) the number of questions students scored less than 10% above failing, and (iv) the number of responses that students received some credit on.
